(19) United States
(12) Patent Application Publication
(10) Pub. No.: US 2007/0086142 A1
(43) Pub. Date: Apr. 19, 2007

(54) Fluid assisted emitter tip and method

(75) Inventor: Jeffrey M. Salisbury, Lakeville, MN (US)

Correspondence Address: Fellers, Snider, Blankenship, Bailey & Tippens, Suite 1700, 100 North Broadway, Oklahoma City, OK, 73102-8820, US

(73) Assignee: Seagate Technology LLC, Scotts Valley, CA (US)

(21) Appl. No.: 11/250,599

(22) Filed: Oct. 14, 2005

(51) Int. Cl. H02H 1/00

(52) U.S. Cl. 361/212

(57) ABSTRACT

An emitter tip for a corona discharge device. The emitter tip comprises an elongated body with a tapered end. The body defines a central passage and the tapered end defines a tip passage in fluid communication with the central passage. A method is provided for controlling electrostatic charge comprising providing a voltage source; providing a pressurized fluid source; connecting the emitter tip to the voltage source and to the fluid source; passing the fluid through the emitter tip; and electrically energizing the emitter tip.

### FIELD OF THE INVENTION

The embodiments of the present invention relate generally to the field of electrostatic charge control and more particularly without limitation to corona discharge emitter tips.

### BACKGROUND

Corona discharge ionizer devices are commonly used for controlling the presence of electrostatic charge in manufacturing environments involving sensitive components, such as in the semiconductor and data storage device industries. Corona discharge ionizers employ a number of emitter tips that, when energized with a sufficiently high voltage, create a corona discharge. The corona discharge is an ion cloud having a charge established by the polarity of the voltage. In many cases a non-hydrogen fluid stream is passed over the emitter tips in order to direct and advance the ion stream in order to statically charge or discharge a work piece. However, problems exist in the current state and use of corona discharge ionizers.

One problem is the tendency for precipitating ammonium nitrate on the emitter tip. In order for the tip to effectively create the corona discharge, the emitter tip must remain clean, sharp, and electrically conductive. Such a buildup reduces the tip's effectiveness in creating the corona discharge. Regularly scheduling maintenance activities to clean or replace the emitter tips can be a costly and unworkable production interruption.

Another problem is associated with bursts of submicron particles coming from the emitter tips that can be introduced into the manufacturing environment. In some cases the contamination comes from sputtering of the material from which the emitter tip is manufactured; in other cases the contamination is particles of the ammonium nitrate precipitation.

While various approaches have been proposed in the art to address the contamination that can be introduced into the manufacturing process by emitter tips, there nevertheless remains a continued need for improvements in the art. It is to such improvements that the claimed invention is directed.

### SUMMARY OF THE INVENTION

Embodiments of the present invention contemplate an emitter tip for a corona discharge device. The emitter tip comprises an elongated body with a tapered end. The body defines a central passage and the tapered end defines a tip passage in fluid communication with the central passage.

In some embodiments a method is provided for controlling electrostatic charge. The method comprises providing a voltage source; providing a pressurized fluid source; connecting the emitter tip to the voltage source and to the fluid source; passing the fluid through the emitter tip; and electrically energizing the emitter tip.

In other embodiments a corona discharge device is provided, comprising a voltage source connected to an emitter tip; and an arrangement for preparing a work piece for manufacturing by steps for controlling the electrostatic charge of the work piece. The steps for controlling is characterized by connecting a voltage source and a pressurized fluid source to the emitter tip, and by passing the pressurized fluid through the emitter tip while electrically energizing the emitter tip.

These and various other features and advantages which characterize the claimed invention will become apparent upon reading the following detailed description and upon reviewing the associated drawings.

### BRIEF DESCRIPTION OF THE DRAWINGS

FIG. 1 is a diagrammatic view of a corona discharge device constructed in accordance with embodiments of the present invention.

FIG. 2 is a side elevational view of an emitter tip of the corona discharge device of FIG. 1 constructed in accordance with embodiments of the present invention.

FIG. 3 is a front elevational view of the emitter tip of FIG. 2

FIG. 4 is a block diagram of a method for controlling electrostatic charge illustrating steps for practicing the embodiments of the present invention.

FIG. 5 is a side elevational view of the emitter tip of FIG. 2 utilized in accordance with alternative embodiments of the corona discharge device of FIG. 1.

### DETAILED DESCRIPTION

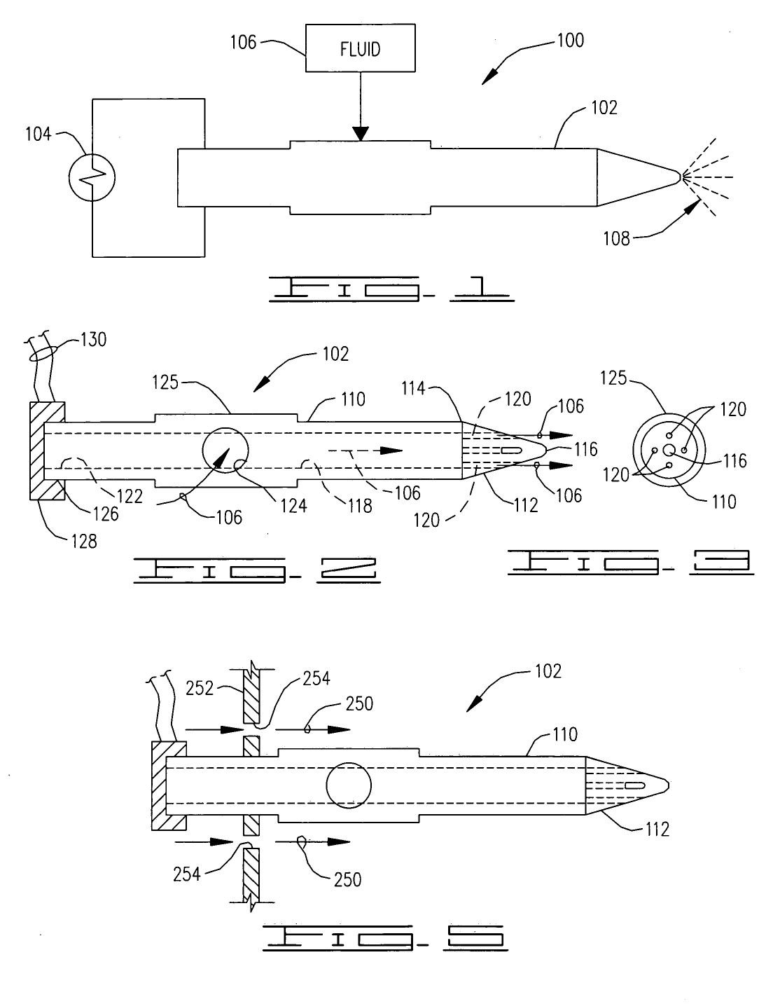

FIG. 1 is a diagrammatic illustration of a corona discharge device 100 constructed in accordance with embodiments of the present invention. The device 100 comprises an emitter tip 102 that is electrically connectable to a high voltage source 104 and to a pressurized fluid source 106. The illustrative embodiments of FIG. 1 identify the voltage source 104 as being an alternating current type voltage source. In equivalent alternative embodiments the voltage source 104 can be a pulsed direct current voltage source, and preferably can be a direct current steady state voltage source. The voltage source 104 electrically energizes the tip 102 which, by way of its construction, emits a corona discharge 108 of electrically charged ions. The pressurized fluid 106 aids in protecting the emitter tip 102 from adverse deterioration and/or ammonium nitrate precipitation by delivering a supply of pressurized fluid into the emitter tip 102. The pressurized fluid 106 can also aid in propelling the ions toward a target object.

FIG. 2 is a side elevational view of the emitter tip 102, which generally comprises an elongated body 110 with a tapered end 112. In the illustrative embodiments of FIG. 1, the body 110 defines a circular cross section with a diameter of about 0.100 inches. The tapered end 112 is substantially contiguous with the body 110 at a proximal end 114 thereof, and can terminate in a sharp or a radiused tip portion at a distal end 116. In preferred embodiments the distal end 116 defines about a 0.003 inch radius. In the circular cross section embodiments of FIG. 2 the tapered end 112 is conical.

The body 110 defines a longitudinal central passage 118. The tapered end 112 defines one or more tip passages 120 passing through the tapered end 112 and in fluid communication with the central passage 118. In the illustrative embodiments of FIG. 2 the tip passage 120 has a bore diameter of about 0.01 inches. In this arrangement, pressurized fluid from the fluid source 106 (FIG. 1) can be delivered into the central passage 118 and expelled through the one or more tip passages 120.

The formation of ammonium nitrate is significantly reduced by passing an appropriate fluid through the tip passages 120 while electrically operating the emitter tip 102. Ammonium nitrate is a compound formed of nitrogen, hydrogen, and oxygen. Thus, a source of hydrogen is necessary to precipitate ammonium nitrate. One source of hydrogen is atmospheric water vapor. By flowing a sufficiently dry gas through the tip passage 120 and thereby onto the distal end 116, no ammonium nitrate can precipitate. Accordingly, the fluid source 106 can supply a pressurized and clean, non-hydrogen gas such as but not limited to dry air, oxygen, carbon dioxide, nitrogen, argon, or helium. It will be noted that passing the fluid from the fluid source 106 inside the emitter tip 102 rather than over it significantly reduces the volume of fluid that is necessary to prevent the unwanted precipitation.

In some embodiments (not shown), the pressurized fluid from the fluid source 106 (FIG. 1) can be connected by an appropriate conduit and connector arrangement attached to an open end 122 of the central passage 118. Alternatively, as shown in the embodiments of FIG. 2, the body 110 can define a transverse opening 124 in fluid communication with the central passage 118. A connector (not shown), such as a barbed fitting, can be attached to the opening 124 for attaching a conduit from the fluid source 106 (FIG. 1). It may be necessary, as illustrated in FIG. 2, to enlarge a portion 125 of the body 110 around the opening 124 in order to accommodate the fitting.

A connecting end 126 of the body 110, opposite the tapered end 112, is configured for electrically engaging a socket 128 which is, in turn, electrically connected to the high voltage source 104 (FIG. 1) by leads 130. In some embodiments illustrated in FIG. 2 the voltage source 104 provides a voltage in the range of about 2,000 to 15,000 volts.

In some embodiments illustrated by FIG. 2 the tip passage 120 is disposed substantially collinearly with the central passage 118. In other words, the tip passage 120 is disposed substantially transverse to a plane defined by the proximal end 114 of the tapered end 112. Alternatively, in some embodiments (not shown), the tip passage 120 can be directed toward or away from the distal end 116. In any event, preferably the tip passage 120 intersects a medial portion of the tapered end 112 between the proximal end 114 and the distal end 116, thereby preventing the tip passage 120 from interfering with the corona discharge formed at the sharp distal end 116.

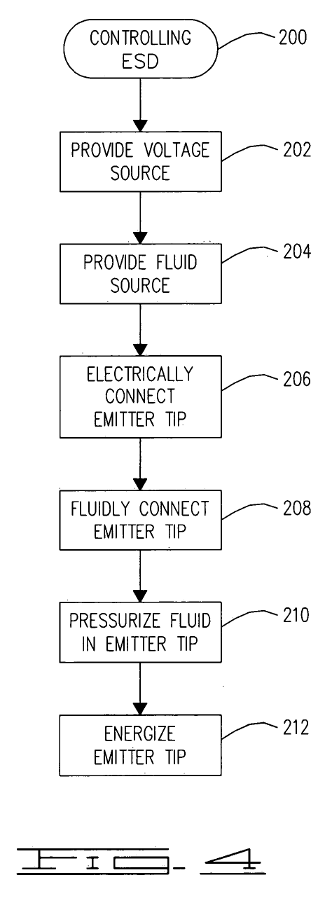

FIG. 3 best illustrates embodiments contemplate two or more tip passages 120 in the tapered end 112. Preferably, the tip passages 120 are equidistantly arranged around the tapered end 112.

In some embodiments the emitter tip 102 can be machined from pin stock to the desired body 110 size and tapered end 112 configuration. A drilling operation can be used to manufacture the central passage 118, and an electrodischarge machining (EDM) operation can be used to manufacture the tip passage 120.

FIG. 4 is a block diagram of a method 200 for CONTROLLING ELECTROSTATIC CHARGE illustrating steps for carrying out the embodiments of the present invention with the apparatus discussed above. The method begins at step 202 by providing the voltage source 104, which includes providing the electrical connector 128 for electrically engaging the emitter tip 102, and providing the interconnecting leads 130. The method continues at step 204 by providing the fluid source 106, which includes providing the fluid connector (not shown), such as for attachment in the opening 124, and providing the interconnecting conduit (not shown).

In step 206 the emitter tip 102 is electrically connected to the voltage source 104. In step 208 the emitter tip 102 is fluidly connected to the fluid source 106. The method then provides pressurized fluid to the emitter tip 102 at step 210, and finally electrically energizes the emitter tip at step 212.

FIG. 5 is a side elevational view of the emitter tip 102 utilized in accordance with alternative embodiments of the corona discharge device of FIG. 1. Here, in addition to the fluid from the fluid source 106 (FIG. 1) flowing inside the emitter tip 102, an additional fluid flow 250 is provided in order to further advance the ionized particles toward a work piece (not shown). The fluid flow 250 can be directed around the emitter tip 102 by a dielectric partition 252 that defines one or more openings 254 for passing the fluid flow 250.

Summarizing generally, an emitter tip (such as 102) is provided for a corona discharge device (such as 100). The emitter tip comprises an elongated body (such as 110) with a tapered end (such as 112). The body defines a central passage (such as 118) and the tapered end defines a tip passage (such as 120) in fluid communication with the central passage.

The body defines a characteristic size, and the tapered end is substantially contiguous with the body at a proximal end (such as 114) thereof, and terminates in a sharp or radiused tip portion at a distal end (such as 116) thereof. In some embodiments the body is circular and the tapered end is conical.

The tip passage is disposed substantially transverse to a plane defined by the proximal end of the tapered end. The tip passage is disposed at a medial portion of the tapered end between the proximal and distal ends. Preferably, the tapered end comprises two or more tip passages which are equidistantly arranged around the tapered end.

In some embodiments a method for controlling electrostatic charge is provided, comprising providing a voltage source; providing a pressurized fluid source; providing a corona discharge emitter tip; connecting the emitter tip to the voltage source and to the fluid source; passing the fluid through the emitter tip; and electrically energizing the emitter tip.

In some embodiments the providing a corona discharge emitter tip step comprises forming the emitter tip as comprising an elongated body with a tapered end, the body defining a central passage and the tapered end defining a tip passage in fluid communication with the central passage.

In some embodiments the providing a corona discharge emitter tip comprises forming the body with an outer surface defining a characteristic size, and forming the tapered end at a proximal end thereof as being substantially contiguous with the outer surface, and terminating the tapered end at a distal end thereof as a sharp or radiused tip portion. The outer surface can be circular and the tapered end accordingly can be conical.

In some embodiments the providing a corona discharge emitter tip comprises disposing the tip passage substantially transverse to a plane defined by the proximal end of the tapered end. The tip passage is preferably disposed at a medial portion of the tapered end between the proximal and distal ends. The emitter tip can comprise disposing two or more tip passages in the tapered end, wherein the tip passages are arranged equidistantly around the tapered end.

In some embodiments a corona discharge ionizer device is provided, comprising a voltage source connected to a corona ionizer emitter tip; and steps for controlling contamination operably created on the emitter tip by the voltage source. The steps for controlling are characterized by connecting a voltage source and a pressurized fluid source to the emitter tip. The steps for controlling are further characterized by passing the pressurized fluid through the tip while electrically energizing the tip.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the particular elements may vary depending on the particular configuration and arrangement of the emitter tip body and tapered end portions without departing from the spirit and scope of the present invention.

What is claimed is:

1. An emitter tip for a corona discharge device, the tip comprising an elongated body with a tapered end, the body defining a central passage and the tapered end defining a tip passage in fluid communication with the central passage.

2. The device of claim 1 wherein the body comprises an outer surface defining a characteristic size, and wherein the tapered end is substantially contiguous with the outer surface at a proximal end thereof and terminates in a tip portion at a distal end thereof.

3. The device of claim 2 wherein the outer surface is circular and the tapered end is conical.

4. The device of claim 2 wherein the tip passage is disposed substantially transverse to a plane defined by the proximal end of the tapered end.

5. The device of claim 2 wherein the tip passage is disposed at a medial portion of the tapered end between the proximal and distal ends.

6. The device of claim 2 comprising two or more tip passages.

7. The device of claim 6 wherein the tip passages are equidistantly arranged around the tapered end.

8. A method for controlling electrostatic charge comprising:
providing a voltage source;
providing a pressurized fluid source;
providing a corona discharge emitter tip;
connecting the emitter tip to the voltage source and to the fluid source; and
passing the fluid through the emitter tip; and
electrically energizing the emitter tip.

9. The method of claim 8 wherein the providing a corona discharge emitter tip step comprises forming the emitter tip as comprising an elongated body with a tapered end, the body defining a central passage and the tapered end defining a tip passage in fluid communication with the central passage.

10. The method of claim 9 wherein the providing a corona discharge emitter tip comprises forming the body with an outer surface defining a characteristic size, and forming the tapered end at a proximal end thereof as being substantially contiguous with the outer surface, and terminating the tapered end at a distal end thereof as a radiused tip portion.

11. The method of claim 10 wherein the providing a corona discharge emitter tip comprises forming the outer surface as being circular and the tapered end as being conical.

12. The method of claim 9 wherein the providing a corona discharge emitter tip comprises disposing the tip passage substantially transverse to a plane defined by the proximal end of the tapered end.

13. The method of claim 9 wherein the providing a corona discharge emitter tip comprises disposing the tip passage at a medial portion of the tapered end between the proximal and distal ends.

14. The method of claim 9 wherein the providing a corona discharge emitter tip comprises disposing two or more tip passages in the tapered end.

15. The method of claim 14 wherein the providing a corona discharge emitter tip comprises arranging the tip passages equidistantly around the tapered end.

16. A corona discharge device comprising:
a voltage source connected to an emitter tip; and
an arrangement for preparing a work piece for manufacturing by steps for controlling the electrostatic charge of the work piece.

17. The device of claim 16 wherein the steps for controlling comprises connecting a voltage source and a pressurized fluid source to the emitter tip.

18. The device of claim 17 wherein the steps for controlling comprises passing the pressurized fluid through the tip while electrically energizing the tip.

19. The device of claim 18 wherein the steps for controlling comprises selecting a fluid that does not comprise hydrogen.

20. The device of claim 18 wherein the steps for controlling comprises passing a pressurized fluid over the tip while electrically energizing the tip.
